(19) United States
(12) Patent Application Publication
(10) Pub. No.: US 2007/0141308 A1
(43) Pub. Date: Jun. 21, 2007

(54) FOAMING SURFACE TREATMENT

(76) Inventor: Ronald M. Studer, Bucyrus, OH (US)

Correspondence Address: PEARNE & GORDON LLP, 1801 EAST 9TH STREET, SUITE 1200, CLEVELAND, OH, 44114-3108, US

(21) Appl. No.: 11/608,505

(22) Filed: Dec. 8, 2006

Related U.S. Application Data
(60) Provisional application No. 60/749,196, filed on Dec. 9, 2005.
(60) Provisional application No. 60/743,636, filed on Mar. 22, 2006.

(51) Int. Cl. B32B 3/12; B05D 3/00; B05D 7/00; B05D 1/28

(52) U.S. Cl. 428/160; 427/140; 427/429; 427/355; 427/421.1; 428/423.1; 428/161

(57) ABSTRACT

A coating for a substrate includes a foaming material that foams when activated by an activating agent. The coating also includes the activating agent. The coating is applied to an exposed surface of the substrate and cures thereon to form a surface treatment on the exposed surface of the substrate.

### CROSS-REFERENCE TO RELATED APPLICATIONS

This application claims the benefit of U.S. Provisional Application No. 60/749,196, filed Dec. 9, 2005 and U.S. Provisional Application No. 60/743,636, filed Mar. 22, 2006, the disclosures of which are incorporated herein by reference.

### BACKGROUND OF THE INVENTION

1. Field of the Invention

The present invention relates to coatings, and more particularly to a foaming surface treatment for a substrate.

2. Description of Related Art

Conventional coatings, and paints in particular, are used mainly for aesthetic or surface protective purposes. A priming coat is generally needed to cover up pores or cracks in a substrate, to ensure that the coating adheres only to the surface of the substrate, thereby minimizing imperfections in the final coating surface.

Because conventional coatings merely protect the surface of a substrate rather than the internal or external structural integrity of the substrate, the structure may deteriorate. A coating on a deteriorated surface, or a surface exposed to harsh conditions, such as a roofing surface or a basement wall, may be damaged by the environment to which it is exposed. Even worse, the surface of a substrate may itself come loose or detach, thereby exposing an uncoated substrate.

Deteriorated surfaces, such as deteriorated wood surfaces, or porous surfaces, such as concrete block, can require painting and repainting and caulking and re-caulking to stop water leaks and further deterioration of the materials caused by the weather, for example. Further repainting of an increasingly deteriorating surface can require more paint, and time to apply the paint, when compared to an earlier repainting, due to further deterioration. It can take an ever increasing amount of paint, in multiple layers, to seal such deterioration, and in turn, increased time, energy and cost. Sealants may not help these problems.

A durable coating that can expand into porous or damaged areas of a substrate in order to impart, for example, weather and water resistance, and increased strength and insulation, would be beneficial.

### BRIEF SUMMARY OF THE INVENTION

In accordance with one aspect of the invention, provided is a coating for a substrate. The coating includes a foaming material that foams when activated by an activating agent. The coating also includes the activating agent. The coating is applied to an exposed surface of the substrate and cures thereon to form a surface treatment on the exposed surface of the substrate.

In accordance with another aspect of the invention, provided is a method that includes the step of providing a coating for a substrate. The coating includes an activating agent and a foaming material that foams when activated by said activating agent. The method also includes the step of applying the coating to an exposed surface of the substrate, wherein the coating cures on the exposed surface of the substrate to form a surface treatment thereon.

### BRIEF DESCRIPTION OF THE DRAWINGS

FIG. 1 is a perspective view of a foaming surface treatment applied to an assembly of framing and sheeting members;

FIG. 2a is an elevation view of a substrate prior to application of the foaming surface treatment;

FIG. 2b is an elevation view of the substrate of FIG. 2a subsequent to application of the foaming surface treatment;

FIG. 3 is a perspective and elevation view of a concrete block that includes the foaming surface treatment; and

FIG. 4 is an elevation view of a substrate having the foaming surface treatment, which further includes an additive.

### DESCRIPTION OF EXAMPLE EMBODIMENTS

A coating for forming a foaming surface treatment for a substrate. The example embodiment as discussed herein, includes both a foaming material and an activating agent, although formulations not using two separate ingredients could also be used. The foaming material foams when mixed with the activating agent. The example coating, which comprises the foaming material and activating agent, can be applied to a surface of a substrate and cure thereon, to form a surface treatment for the substrate. The coating can be applied to an exposed surface of the substrate, such as a surface exposed to various natural environmental conditions, such as wind, rain, snow, etc. The coating can also be applied to an exposed surface that is subject to various man-made conditions, such as a surface that is subject to sprayed, thrown, or dripping liquids, for example.

In an example embodiment, the foaming material includes a water-activated foaming glue that foams while curing, such as a polyurethane glue, for example. In this case, the activating agent is water. As the foaming glue cures, it expands in volume. Foaming can be achieved, for example, by incorporating a suitable blowing agent into the glue prior to fully curing, such as water into a polyurethane precursor composition (which includes polyols and isocyanates as known in the art). Examples of commercial off-the-shelf products that can be used as foaming polyurethane glues are GORILLA GLUE or ELMER'S ULTIMATE GLUE, which foam as they cure due to the prior or contemporaneous application of moisture to the surface to be glued. The glue foams as it sets, filling gaps or voids that exist between surfaces to be bonded.

In an example embodiment, the activating agent is mixed with the foaming agent and, if desired, a pigment, to form a paint coating. Alternatively, the components might be premixed, and activated in some other manner, such as by exposure to air.

In a more detailed example embodiment, the foaming agent can be a foaming glue as described above, and the activating agent a latex paint. Water in the latex paint is utilized to activate the foaming material (e.g., the glue), so that the foaming material foams. The latex paint provides a desired pigment. Additional pigments can also be added to the coating to achieve any desired color. Thus, in this example embodiment, the coating includes both of a water-activated foaming glue and a water-based paint and optionially additional pigments. Water in the water-based paint activates the foaming glue, causing it to foam. Pigment in the paint, or additional pigments added to the glue-paint mixture, provide the desired color for the coating. Mixing a foaming glue with a water-based paint, or another suitable activating agent, can result in a mixture that is readily spread or painted onto a substrate.

The foaming material and the activating agent can be mixed prior to application of the coating to the exposed surface of the substrate. Pre-mixing the foaming material and activating agent can provide a coating that may be poured onto a substrate, such as onto a cracked or pitted substrate requiring repair. The foaming material and the activating agent can also be mixed at the same time that the coating is applied. For example, the coating can be sprayed onto the substrate, such as with a spray gun, and the foaming material and activating agent cay be mixed by the spray gun as the coating is applied. The coating could also be applied with a roller, such as a power roller, which mixes the foaming material and activating agent while the coating is applied. The coating could also be painted onto a substrate with a brush. Because some formulations may be difficult to clean off the applicators after curing, it may be beneficial to use disposable brushes or rollers. Spray application may be made using a specialized spray gun that applies additive fibers/fillers to the surface being coated, in addition to mixing the components of the coating. Additives, such as ground up recycled packaging foam or other sources of foam (such as Styrofoam waste, for example), or fiberglass can be coated by the present invention as a filler or to form sheets that can be bended and molded as desired.

The activating agent and the foaming material can be applied to the exposed surface of the substrate simultaneously, or they can be applied at different times. For example, the activating agent can be applied to the substrate first, followed by the foaming material at a later time, or vice versa.

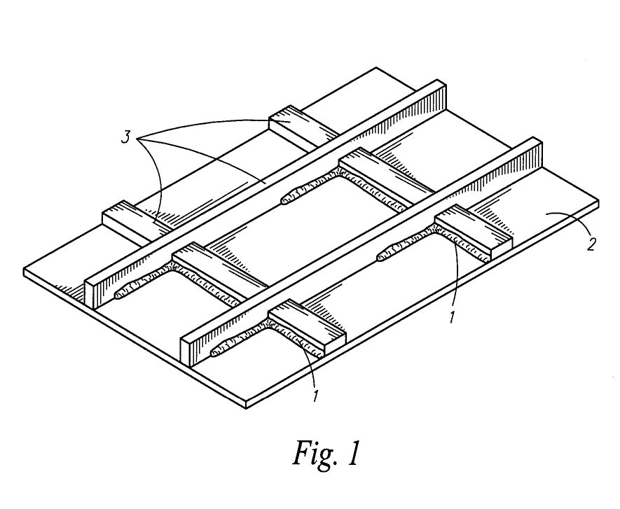

Turning to the figures, FIG. 1 shows a wood frame 3, which is attached to a plywood sheet 2. The coating 1 has been applied to the frame 3 and plywood sheet 2, which are substrates for the coating. The coating 1 fills voids between the frame 3 and plywood sheet 2 and can hold the assembly together, or can be used to strengthen the joints between individual framing members or between a framing member and the plywood sheet 2.

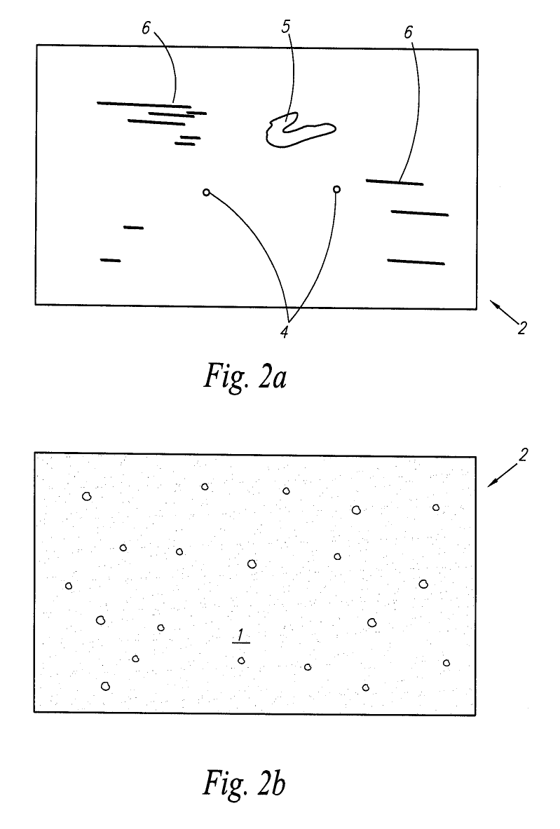

FIGS. 2a and 2b, respectively, show “before” and “after” figures of a plywood sheet 2, to which the coating is applied. In an embodiment, the plywood sheet 2 is sheeting for a roof. In the “before” FIG. (2a), the plywood contains screw holes 4, factory patching 5 of the plywood surface, and delaminated portions 6 of the wood. In the “after” FIG. (2b) the coating both coats the exposed surface of the plywood sheet 2 and fills/repairs the screw holes 4, factory patching 5, and delaminated portions 6. As shown in FIG. 2b, the coating 1 forms pores on its surface due to its foaming action.

The coating can penetrate the seams between separate sheets, repairing deteriorated edges of the sheets at the seams and, additionally, migrate into any gaps between sheets and the framing beneath them. The coating can foam through gaps between sheets and onto the framing members that support the sheets, repairing deteriorated areas of the framing itself and, additionally, securing the sheets to the framing members. For example, the coating can be painted onto (brushed, sprayed, rolled, etc.) the exposed surface of a structure's sheeting material, such as the exposed plywood or oriented strand board of a wall. The coating can foam through gaps between the individual sheets and help secure the wall to its framing members. Also, the coating could be applied to a roof to coat its surface and fill any voids or holes therein, and fill any voids between the roofs sheeting material, thereby providing a surface treatment for a roof system.

As discussed above, the coating provides a surface treatment for a substrate and can help strengthen and tighten the components of a structure. It is to be appreciated that the coating could be applied to the surface of construction framing members, joints between framing members, joints between framing members and sheeting material, and on sheeting material surfaces and joints between sheeting material. The coating not only creates foam on the surface of a substrate but penetrates and migrates through any pores of the substrate to its interior as well, creating foam internally as though the structure were injected with foam. Thus, this coating creates a composite structure by penetrating and migrating deep into the substrate. Such penetration of foam will serve as insulation. In addition, the coating can be utilized as a radon shield to protect against radon migration into an area, such as a basement, for example. It can also be used to protect against air leaks and water leaks. The coating can also be used to penetrate into a layered substrate, and secure a top layer of a layered substrate to an intermediate or bottom layer of the substrate.

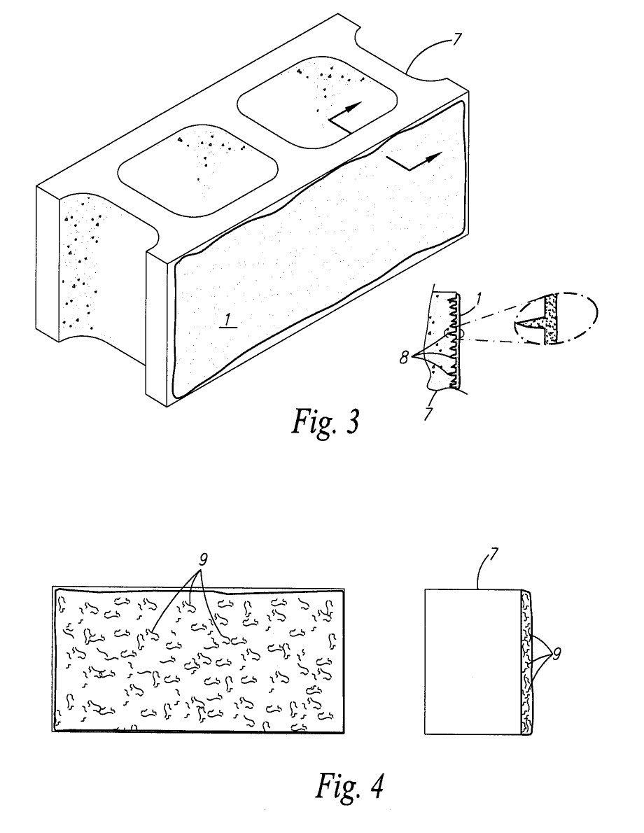

FIG. 3 shows the coating 1 applied to a concrete block 7. The coating 1 expands and fills pores 8 in the concrete block 7. The coating can be used to hold damaged portions of the concrete block together, such as securing a cracked portion of the block. The coating can also be used to seal, color, waterproof, and insulate the concrete block. The coating can be used on interior basement walls and can be applied to the exterior of basement walls prior to backfilling. After being applied to a concrete block wall for example, the coating may not wash out as easily as conventional cement and hydraulic cement paints. The coating can be used to repair a damaged wall or other substrate by penetrating into cracks in the wall, thereby holding the cracking substrate together. It is to be appreciated that foaming paint can be used on interior/exterior masonry for other applications as well, such as soundproofing, for example.

Additives can be included in the coating to change its properties, such as increase its strength or change its color. For example, FIG. 4 shows the concrete block 7 of FIG. 3 with a coating that includes fiberglass strands 9. Additives, such as strengthening fiberglass fibers, or fillers, such as sand, sawdust, etc. may be added to or used in conjunction with the coating to enhance the strength that the coating imparts to structures, and to increase volume of the coating and help hold the substrate in place, and provide a strong, textured surface. The additives can be provided pre-mixed in the foaming material or activating agent, or they can be supplied separately, such as in the form of a fiberglass mat or individual fiberglass strands which are mixed into or injected into the coating. For example, individual fiberglass fibers could by injected and suspended in the coating while the coating is being sprayed onto a substrate.

In addition, depending on the desired finish (gloss, textured, etc.), further additives may be incorporated into the coating. For example, the gas trapped in the coating affects its finish. If a spongy faux finish is desired, a surfacing agent can be used to trap more gas on the film surface, thereby causing more trapped gas and therefore foam. However, if a tougher finish is desired, additives, such as surfactants, may be used to allow gasses to escape during curing to thereby cause a foam decrease. Different finish textures can be achieved by covering with plastic sheeting a surface to which the coating has been applied, before it fully cures. Covering the coating with plastic sheeting may increase the penetrating depth of coating into the substrate and increase the sponginess of the coating.

Multiple compositions of the coating may be used to obtain desired properties. For example, slow activating or fast activating compositions could be formulated. Also, submersible formulations could be made so that the coating could be used in wet locations, such as on the bottoms of fence posts, telephone poles, concrete drainage culverts, etc. One could reformulate the coating to form a product that is submersible. The coating can be reformulated to plasticize, rubberize, metalize, etc. the end product. A sprayable composition dispensed as a rubberized foaming coating could be used as a sound deadener in cars, home or industry. The desired property of the mixture will dictate the appropriate formulation and additives.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A coating for a substrate, comprising:
a foaming material that foams when activated by an activating agent; and
the activating agent, wherein the coating is applied to an exposed surface of the substrate wherein the coating foams, expands, and cures thereon to form a surface treatment on the exposed surface of the substrate.

2. A coating for a substrate as set forth in claim 1, wherein the foaming material includes a polyurethane glue and the activating agent is water.

3. A coating for a substrate as set forth in claim 2, wherein the activating agent is included in a latex paint.

4. A coating for a substrate as set forth in claim 1, further comprising a pigment for providing a colored coating.

5. A coating for a substrate as set forth in claim 1, further comprising a fiberglass additive.

6. A coating for a substrate as set forth in claim 1, wherein the foaming material and the activating agent are mixed prior to application of the coating to the exposed surface.

7. A coating for a substrate as set forth in claim 1, wherein the foaming material and the activating agent are mixed while the coating is applied to the exposed surface of the substrate of the coating to the exposed surface.

8. A coating for a substrate as set forth in claim 1, wherein the substrate forms a plurality of pores and the coating fills the pores and cures therein.

9. A coating for a substrate as set forth in claim 1, wherein the substrate forms a crack and the coating at least partially fills the crack and cures therein.

10. A coating for a substrate as set forth in claim 1, further comprising a second substrate having an exposed surface to which the coating is applied, wherein the coating bonds said substrates together.

11. A method, comprising the steps of:
providing a coating for a substrate, wherein the coating includes a foaming material that foams when activated by an activating agent; and
applying the coating to an exposed surface of the substrate, wherein the coating foams, expands, and cures on the exposed surface of the substrate to form a surface treatment thereon.

12. A method as set forth in claim 11, wherein the step of applying includes the step of applying the coating to the exposed surface of the substrate using a brush.

13. A method as set forth in claim 11, wherein the step of applying includes the step of applying the coating to the exposed surface of the substrate using a roller.

14. A method as set forth in claim 13, wherein the roller is a power roller.

15. A method as set forth in claim 11, wherein the step of applying includes the step of spraying the coating onto the exposed surface of the substrate.

16. A method as set forth in claim 11, wherein the wherein the foaming material includes a polyurethane glue and the activating agent is water from a latex paint.

17. A method as set forth in claim 11, further comprising the step of mixing the activating agent and the foaming material prior to performing the step of applying.

18. A method as set forth in claim 11, wherein the activating agent and the foaming material are not simultaneously applied to the exposed surface of the substrate.

19. A method of coating an exposed surface having surface imperfections, said method comprising the steps of:
providing a foaming agent;
providing an activating agent;
providing a pigment;
mixing said foaming agent with said activating agent and said pigment to form a surface treatment;
applying said surface treatment to the exposed surface, wherein said surface treatment foams and substantially expands to cover at least a portion of said exposed surface and fill said surface imperfections of said portion; and
allowing said surface treatment to cure, thereby forming said coating.

20. The method of claim 19, wherein said activating agent includes said pigment in a pigmented paint which is mixed with said foaming agent.
